(19) United States
(12) Patent Application Publication
(10) Pub. No.: US 2010/0192420 A1
(43) Pub. Date: Aug. 5, 2010

(54) WEAR SOLE FOR FOOTWEAR ITEM AND METHOD AND MOULD FOR MAKING SUCH A SOLE

(76) Inventor: Bernard Favraud, Cholet (FR)

Correspondence Address: YOUNG & THOMPSON, 209 Madison Street, Suite 500, Alexandria, VA, 22314, US

(21) Appl. No.: 12/670,543

(22) PCT Filed: Jul. 9, 2008
(86) PCT No.: PCT/FR08/01003

§ 371 Date: Jan. 25, 2010

(30) Foreign Application Priority Data
Jul. 25, 2007 (FR) 0705436

(51) Int. Cl. A43B 7/06; A43B 13/18; A43D 8/00; B29C 43/36

(52) U.S. Cl. 36/3 B; 36/28; 12/146 B; 425/119

(57) ABSTRACT

A wear sole (1) for a footwear of the type in which a portion at least of the bearing outer surface (2) of the sole is made of a single piece and has protruding portions (3) and empty gaps (6) provided between the protruding portions (3), each protruding portion (3) being formed from an emptied embossment (3) of the sole defining a cavity (4) open on the side of the inner surface (15) of the sole, the embossments (3) being connected together by a portion of the sole defining a bridge (7). The sole is characterized in that a portion at least of the sole portion defining the bridge between the embossments (3) is provided with through holes (8) for permanent communication between the inner (15) and outer (2) surfaces of the sole, the openings (8) being closed by a watertight membrane (9) that is pervious to steam and air.

This invention relates to an outsole for footwear as well as a process and a mold for the manufacturing of said sole.

It relates more particularly to an outsole for footwear of the type of which at least a portion of the outside support surface of the sole has projecting parts, arranged at and/or on the periphery of the support zones of the foot and empty spaces arranged between the projecting parts, whereby each projecting part is formed from a scooped-out projection of the sole that delimits an open cavity on the inside surface of the sole, whereby said projections are connected to one another by a portion of the sole that forms a bridge.

Such soles make it possible—because of the configuration of their outside surfaces—to implement a stabilization of the foot in the shoe and to limit the collapse of certain areas of the foot while working with the elastic deformation of the latter up to a certain limit where this deformation becomes excessive and runs the risk of being traumatic.

The empty spaces form arches between the projections. Under the action of pressure, the projections can be compressed or come to rest on the bottom of the shoe to ensure—according to their nature—the stabilization of the foot if these projections are relatively rigid or the absorption of shocks. If they are made of an absorbent material that stores energy that will be restored when the pressure decreases, walking and running are promoted by conserving muscular energy.

Such a sole therefore achieves increased comfort, good distribution of support with removal of load from zones where the supports are most significant, stabilization and monitoring of the deformation of the foot, a return of energy as well as a massaging of the arch of the foot and stimulation of the blood.

The example of such a sole is described in particular in the international application PCT/FR2003/002798.

By the same token, breathing soles, as the patent EP 0 910 964 illustrates, have appeared on the market.

In this case, the sole that is made of an elastomer is shaped so as to form a number of domes that have a convexity directed toward the ground. Each dome forms a chamber and has at least one very small through slot that is normally closed under the action of the elasticity of the material and that makes possible an outside flow of a mixture of air and water vapor formed inside the shoe when a compression that is applied by the sole of the user's foot generates overpressure at the chambers that are formed on the inside by said dome. This sole is equipped with a water-tight and vapor-permeable membrane that is inserted between said sole and a first vapor-permeable or perforated membrane that is combined with said sole. The lower part of the rod that works with the sole, the sole and the membrane are sealed in a perimetric manner in regions where the sole and the membrane are joined.

This solution is not satisfactory because it does not make possible permanent respiration of the sole because the holes open only during a deformation of said sole. Furthermore, the outside shape of the sole that corresponds to the support surface on the ground of said sole is not designed for allowing good distribution of the supports.

It is the same for the sole that is described in the European Patent EP 0 382 904. This patent describes a sole structure for a shoe that comprises at least one lower part that has an outside surface and at least one upper part that is attached to the lower part. The lower part has a number of micropores that pass through its thickness and is covered by at least one membrane that is manufactured from a water-tight microporous material that is able to allow transpiration. The upper part, attached to the lower part, has holes that pass through its entire thickness. In this case, the entire sole is covered by through holes such that in the event of rain, risks of accumulating water between the sole and the water-impermeable membrane are high, leading to the creation of an uncomfortable water pocket inside said shoe. Furthermore, the breathing zones of the shoe are provided in deformable zones of said shoe such that, again, the breathing of this shoe cannot be ensured in all circumstances based on the deformations undergone by said shoe.

By way of the general state of the art, the document US 2006/143942 that describes a sole that comprises a single scooped-out projection that is combined with two filters that are designed solely to prevent the intrusion of debris can be cited.

The documents FR-A-2,863,457, DE 20 2004 000307, WO 2007/054983 and WO 2005/070658 that describe outsoles comprising localized membranes can also be cited. These soles do not have any characteristic that makes it possible to obtain a comfortable sole that can ensure a high level of absorption based on the morphology of the user in which the risk of a water pocket forming between the membrane and the sole is reduced.

One object of this invention is to propose a sole whose design makes it possible to ensure a behavior that is independent of each individual surface of the sole that is made in the form of a projection so as to be able to adapt to the characteristics of morphology and behavior, in particular in terms of contact pressure of each foot while allowing permanent breathing of said sole.

Another object of this invention is to propose a breathing sole whose design makes it possible, on the one hand, to prevent the formation of a pocket between membrane and sole that can be filled with water when, for example, the sole rests on soaked ground, and, on the other hand, to ensure breathing regardless of the deformations undergone by the sole.

For this purpose, the invention has as its object an outsole for footwear of the type of which at least a portion of the outside support surface of the sole has projecting parts, arranged at and/or on the periphery of the support zones of the foot and empty spaces arranged between the projecting parts, whereby each projecting part is formed from a scooped-out projection of the sole that delimits an open cavity on the inside surface of the sole, whereby said projections are connected to one another by a portion of the sole that forms a bridge, characterized in that at least part of the portion of the sole that forms a bridge between said projections is equipped with through holes for permanent communication between inside and outside surfaces of said sole, whereby said holes are closed by a water-tight membrane that is permeable to water vapor and air.

Because the outside surface of the sole is designed in the form of projections that are separated by empty spaces that form arches between projections and owing to the presence of through holes that are open permanently facing empty spaces, a breathing and comfortable sole is obtained without interfering with this possibility of being used under difficult atmospheric conditions (strong rain, for example). Contrary to the prior art where the through holes are made in a deformable zone of the sole, the arrangement of the through holes in a non-deformable and raised zone of the sole makes it possible to ensure in all circumstances a breathing of the sole without interfering with the comfort of the latter.

According to a preferred embodiment of the invention, the membrane is positioned on the inside surface of the sole and blocks the opening of through holes in said surface.

Preferably, the membrane is a cut membrane that at least partially surrounds the opening of the cavities that are formed by each of the projections by leaving said openings free.

Because of this arrangement, the risk of a water retention pocket forming between sole and membrane is small, and even eliminated. By the same token, each cavity can be packed with any packing, optionally removable, without impairing the action of said membrane and without impeding the operation of the latter.

The invention also has as its object a process for manufacturing an outsole for footwear of the above-mentioned type, using a mold that is made of at least two parts, one being used in the molding of the inside surface and the other in the molding of the outside surface of said sole, whereby said mold parts are mobile between an open position and a closed position in which they delimit a molding cavity inside of which is introduced the constituent molding material of the sole, characterized in that it consists in pre-equipping the mold part that is used in the molding of the outside surface of the sole with wires, mounted on a spring, resting in the closed position of the molding cavity on the mold part that is used in the molding of the portion that forms a bridge from the inside surface of the sole, whereby said wires are installed in the molding cavity at locations that correspond to through holes for communication between inside and outside surfaces of the sole to be formed and to install, before closing the mold, in the manner of an insert, a water-impermeable and air- or water vapor-permeable membrane inside of said cavity, whereby said membrane is inserted between the wires and the mold part that is used in the molding of the inside surface of the sole in the closed state of the mold.

The invention also has as its object a mold for the manufacturing of an outsole, by implementation of the above-mentioned process, whereby said mold comprises at least two parts, one being used in the molding of the inside surface, and the other in the molding of the outside surface of said sole, whereby said mold parts are mobile between an open position and a closed position in which they delimit a molding cavity inside of which the constituent molding material of the sole is introduced, characterized in that the mold part that is used in the molding of the outside surface of said sole is pre-equipped with wires, mounted on a spring, resting in the closed position of the cavity on the mold part that is used in the molding of the portion that forms a bridge from the inside surface of the sole, whereby said wires are installed in the molding cavity at locations that correspond to the through holes for communication between inside and outside surfaces of the sole that is to be formed.

The invention will be well understood from reading the following description of embodiments with reference to the accompanying drawings in which:

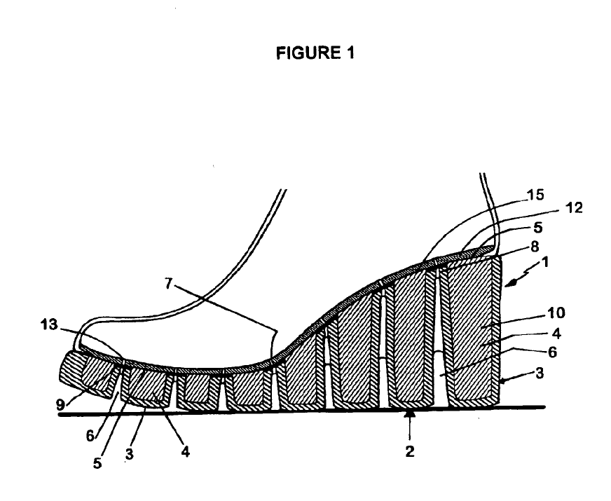

FIG. 1 shows a cutaway view of footwear that is equipped with a sole according to the invention;

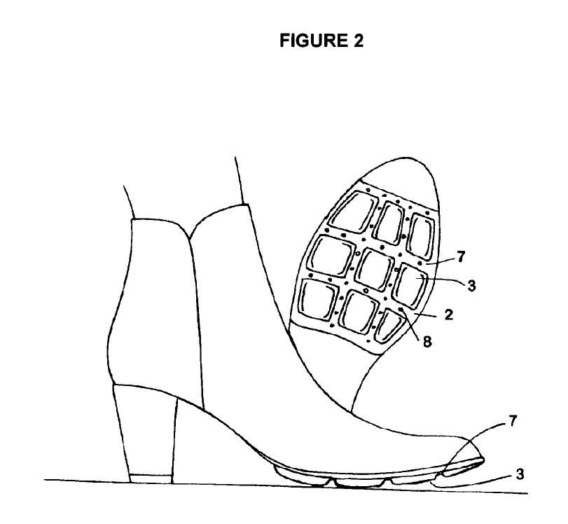

FIG. 2 shows a side and bottom view of footwear that is equipped with a sole according to the invention;

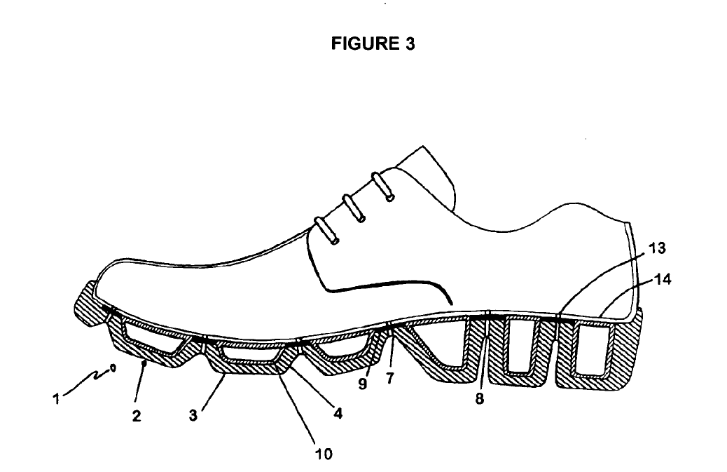

FIG. 3 shows a cutaway view of another embodiment of footwear that is equipped with a sole according to the invention;

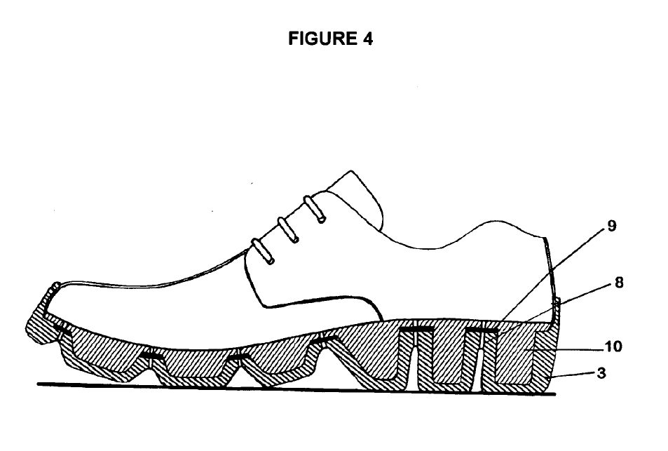

FIG. 4 shows a cutaway view of another embodiment of footwear that is equipped with a sole according to the invention;

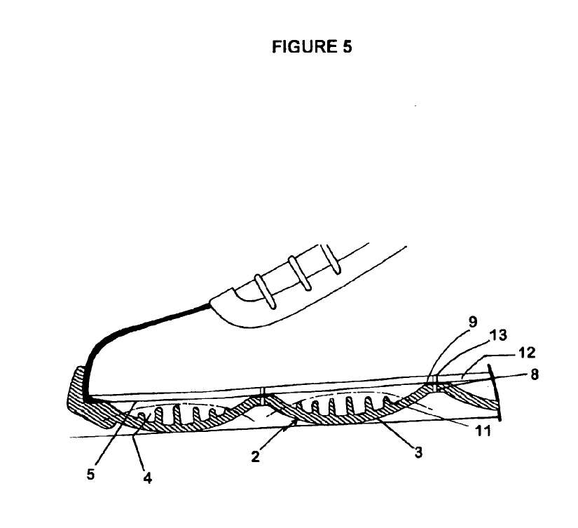

FIG. 5 shows a cutaway view of another embodiment of footwear that is equipped with a sole according to the invention;

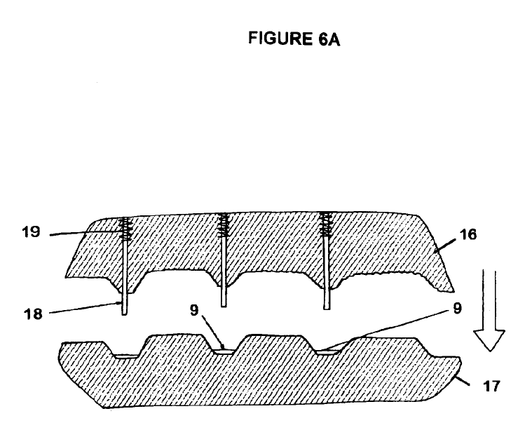

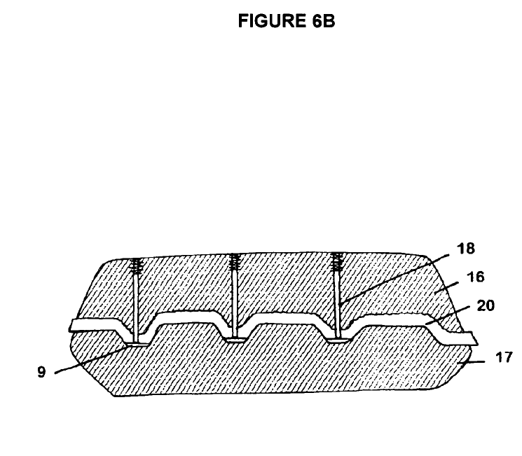

FIGS. 6A and 6B show—in the form of cutaway views—a mold according to the invention, in open position (FIG. 6A) and in closed position (FIG. 6B);

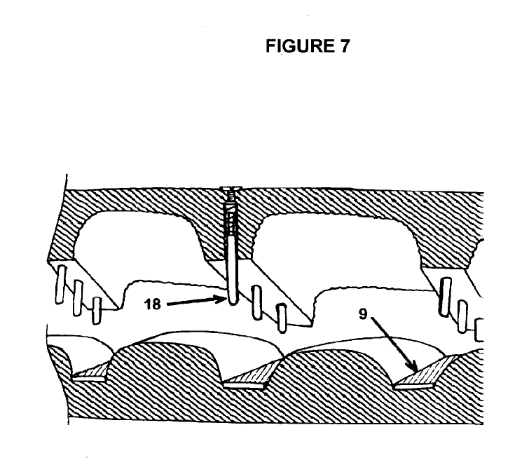

FIG. 7 shows a partial perspective view of the inside of the mold of FIGS. 6A and 6B;

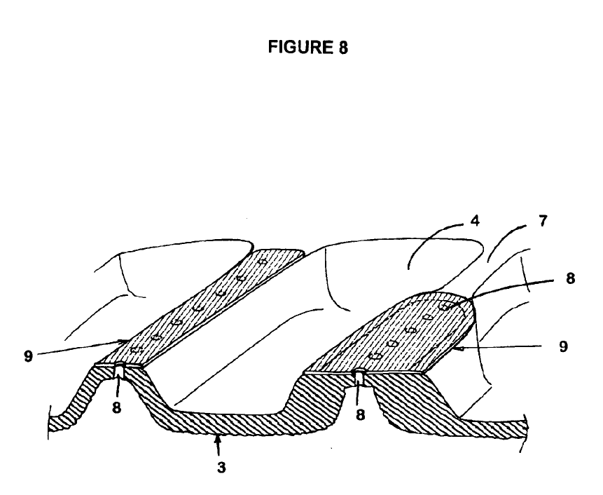

FIG. 8 shows a partial perspective view of the inside surface of a sole according to the invention, and

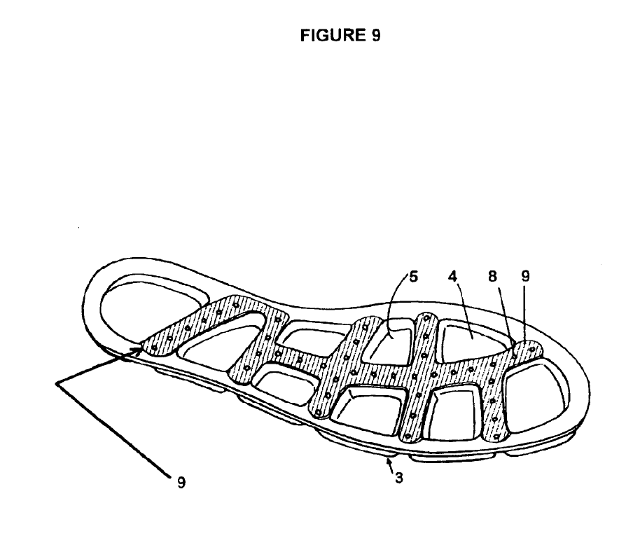

FIG. 9 shows a perspective view of the inside surface of a sole according to the invention.

As mentioned above, the outsole 1, object of the invention, which preferably constitutes a one-piece unit with a single support, has an outside surface 2 that is designed to rest on the ground and an inside surface 15 that is turned toward the user's foot.

At least one part of the outside surface 2 has projecting parts 3 that are installed at and/or on the periphery of the support zones of the foot and empty space 6 that form arches arranged between the projecting parts 3. Each projecting part 3 is formed from a scooped-out projection 3 of the sole 1 that delimits an open cavity 4 that is on the inside surface 15 of the sole. The projections 3 are connected to one another by a portion of the sole that forms a bridge 7. This portion of the sole that forms a bridge 7 that is installed to the right of the empty spaces allows a deformation of the projections 3, independently of one another, based on the feedstock on the inside surface 15 of said sole 1. Better adhesion of the outsole regardless of the ground is thus ensured. It should be noted that in general, projections and portions of the sole that form a bridge are made of a single piece.

In the examples that are shown, the projections 3 have a flat or rounded top. In the case of the rounded top, the projections delimit a ground support surface that is generally lobe-type convex in shape. At the level of these projections 3, the inside surface 15 of the sole has a surface that is generally alveolar in shape.

In a manner that is characteristic of the invention, at least a part of the portion of the sole that forms a bridge 7 between said projections 3 is equipped with through holes 8 for permanent communication between inside surfaces 15 and outside surfaces 2 of said sole 1. These holes 8 are closed by a water-tight membrane 9 that is permeable to water vapor or air. Thanks to the nature of the membrane 9, air can be circulated permanently by means of said through holes 8 between the inside surfaces 15 and outside surfaces 2 of said sole.

Preferably, the membrane 9 is positioned on the inside surface 15 of the sole 1 and blocks the opening of the through holes 8 in said surface 15.

Such membranes, for example such as Goretex (registered trademark), are well known to those skilled in this art and will not be described in more detail below.

By way of example, each bridge 7 has a width between two cavities 4 that is preferably between 0.5 cm and 2 cm for cavities of which the smallest dimension can vary from 1 to 4 cm. In other words, the bridges are sized relative to the cavities of the sole to allow an independent deformation of each cavity 4. The cavities 4 have a depth that is preferably between 0.25 cm and 10 cm. The shapes of the cavities can be diverse and varied.

Preferably, the projections extend into the front part of the sole that corresponds to the sole of the foot.

The membrane 9 is preferably a cut membrane, at least partially surrounding the opening 5 of the cavities 4 that are formed by each of the projections 3 by leaving said openings 5 free.

This membrane 9 therefore covers only the portions that form a bridge 7 between said cavities such that a packing 10 can, if necessary, be inserted into at least some of said cavities.

This solution is preferable to the solution in which the membrane covers the entire inside surface of said sole.

Actually, in general at least a part of the cavities 4 is respectively filled with a packing 10, such as an elastically deformable material.

Preferably, the packing comes in the form of an element made of an elastically deformable material, for example in the form of a flexible pocket of air or foam with a variable density based on the desired absorption characteristics or gel or balls or the like. One elastically deformable element can also comprise a spring.

Each elastically deformable element preferably has a complementary shape of the cavity 4 of the sole 1 so as to just insert by simple locking into said cavity 4 and to assume the contours of the cavity in the inserted state in the latter.

When a load is applied to the outsole, for example during walking, projections as well as the packing elements made of elastically deformable material become deformed.

In one preferred embodiment of the invention, at least one part of the projections is distributed on both sides of a longitudinal axis of the sole. The elastically deformable elements have a hardness that is differentiated on both sides of said axis so as to provide a so-called closed side of the sole and a so-called flexible side of the sole based on the characteristics of distribution of contact pressure from the foot to the sole under static conditions and/or under dynamic conditions.

This differentiated treatment of the elastically deformable elements, depending on whether they are located on the inside of the sole or the outside of the sole, makes it possible to correct the foot positions that are linked to an excessive pronation or a supination. These positions generate hyper-supports that cause accelerated wear of the sole.

To counter the effects of such supports, the elastically deformable elements are treated differently according to their position at the sole.

The packings 10, respectively installed in a cavity 4 of a projection 3, can be independent from one another as FIGS. 1 and 3 illustrate.

In another embodiment that is shown in FIG. 5, at least one part of the cavities 4 is equipped on the inside with studs 11 or compression flanges, originating on the surface that forms the bottom of said cavity 4 and projects in the direction of the interior of said cavity 4. These studs 11 or compression flanges can have a height that is identical or different from one stud to the next.

In another embodiment that is shown in FIG. 4, the elastically deformable elements that are installed respectively in a cavity are connected to one another in the form of a plate that—in the inserted state of elastically deformable elements in the cavities—forms a flat surface that is designed to constitute either directly the support surface of the foot or a surface that is used for receiving a first assembly.

In the example that is shown in FIG. 4, the footwear does not comprise any first assembly. The primary comfort is molded anatomically to the inside surface of the footwear and is molded specifically to be housed inside the cavities of the sole on the opposite surface. This packing can be made removable.

During the manufacturing of the sole, the membrane 9 can be attached to the sole 1 in different ways. In one preferred embodiment, the sole 1 is a molded piece, and the membrane 9 is made integral in an airtight manner to the sole 1 with molding.

To make possible the manufacturing of such a sole, a mold in accordance with FIGS. 6A to 7 is used. To obtain the desired result, a mold is installed in at least two parts of which the mold part 16 that is used for molding the outside surface 2 of the sole 1 is pre-equipped with wires 18 that are mounted on the spring 19. These wires 18 rest, in closed position of the cavity for molding, on the mold part 17 that is used in the molding of the portion that forms a bridge 7 from the inside surface 15 of the sole 1. These wires 18 are installed in the molding cavity at locations that correspond to through holes 8 for communication between inside surfaces 15 and outside surfaces 2 of the sole 1 that is to be formed.

The water-impermeable and air- or water vapor-permeable membrane 9 is installed, before the mold is closed, in the manner of an insert, inside of said molding cavity and is inserted between the wires 18 and the mold part 16 that is used in the molding of the inside surface 15 of the sole 1 in the closed state of the mold. This pre-positioning of the membrane 9 is more particularly visible in FIG. 7.

A result according to the one that is shown in FIG. 8, the left part of said figure, is thus obtained.

In another embodiment that is shown in the right portion in FIG. 8, the membrane 9 is attached to the sole by gluing. It should be noted that in FIGS. 8 and 9, the membrane 9 is shown in transparent form to make possible the display of through holes 8 and in particular the display of their opening in the inside surface 15 of said sole.

Once the membrane 9 is made integral with the sole 1, the sole is made integral with the rod to form footwear. The connecting means between rod and sole can be diverse and varied.

In the secured state of the rod with the sole, the inside surface 15 of the sole 1 is coated either with a first perforated assembly or comfort 12 or a perforated extension of the rod 14, whereby the perforations 13 of the first assembly or comfort 12 or rod 14 extends facing through holes 8 of the sole 1.

FIG. 1 thus illustrates the case where the sole is topped with a first perforated assembly 12. FIG. 3 illustrates the case where the rod 14 extends to form the equivalent of a first assembly, whereby said extension is perforated.

In a particular embodiment of the invention, of the type in which the sole has at least one part of the cavities 4 respectively filled with a packing 10, such as an elastically deformable material, the first assembly or comfort 12 and the packing 10 can be made of a single piece to form the equivalent of what is shown in FIG. 4.

As that which is described above illustrates, there is therefore a large number of embodiments of said sole without exceeding the scope of the invention.

1. Outsole (1) for footwear of the type of which at least a portion of the outside support surface (2) of the sole has projecting parts (3), arranged at and/or on the periphery of the support zones of the foot and empty spaces (6) arranged between the projecting parts (3), whereby each projecting part (3) is formed from a scooped-out projection (3) of the sole (1) that delimits an open cavity (4) on the inside surface (15) of the sole, whereby said projections (3) are connected to one another by a portion of the sole that forms a bridge (7), characterized in that at least a part of the portion of the sole that forms a bridge (7) between said projections (3) is equipped with through holes (8) for permanent communication between inside surfaces (15) and outside surfaces (2) of said sole (1), whereby said holes (8) are closed by a watertight and water vapor- and air-permeable membrane (9).

2. Outsole (1) for footwear according to claim 1, wherein the membrane (9) is positioned on the inside surface (15) of the sole (1) and blocks the opening of the through holes (8) in said surface (15).

3. Outsole (1) for footwear according to claim 2, wherein the membrane (9) is a cut membrane, at least partially surrounding the opening (5) of cavities (4) that are formed by each of the projections (3) by leaving said openings (5) free.

4. Outsole (1) for footwear according to claim 1, wherein the sole (1) is a molded piece and wherein the membrane (9) is made integral in a sealed manner with the sole (1) in the molding.

5. Outsole (1) for footwear according to claim 1, wherein at least a part of the cavities (4) is respectively filled with a packing (10), such as an elastically deformable material.

6. Outsole (1) for footwear according to claim 1, wherein at least a part of the cavities (4) is equipped on the inside with studs (11) or compression flanges, originating on the surface that forms the bottom of said cavity (4) and projects in the direction of the interior of said cavity (4).

7. Outsole (1) for footwear according to claim 1, wherein the inside surface (15) of the sole (1) is coated either with a first perforated assembly or comfort (12) or a perforated extension of the rod (14), whereby the perforations (13) of the first assembly or comfort (12) or rod (14) extend facing through holes (8) of the sole (1).

8. Outsole (1) for footwear, according to claim 7, of the type in which at least a part of the cavities (4) is respectively filled with a packing (10), such as an elastically deformable material, wherein the first assembly or comfort (12) and the packing (10) are made of a single piece.

9. Process for manufacturing an outsole (1) for footwear according to claim 1, using a mold that is made of at least two parts (17, 16), one (17) being used in the molding of the inside surface (15) and the other (16) in the molding of the outside surface (2) of said sole (1), whereby said mold parts (17, 16) are mobile between an open position and a closed position in which they delimit a molding cavity (20) inside of which is introduced the constituent molding material of the sole (1), wherein it consists in pre-equipping the mold part (16) that is used in the molding of the outside surface (2) of the sole (1) with wires (18), mounted on a spring (19), resting in the closed position of the molding cavity on the mold part (17) that is used in the molding of the portion that forms a bridge (7) from the inside surface (15) of the sole (1), whereby said wires (18) are installed in the molding cavity at locations that correspond to through holes (8) for communication between inside surfaces (15) and outside surfaces (2) of the sole to be formed and to install, before closing the mold, in the manner of an insert, a water-impermeable and air- or water vapor-permeable membrane (9), inside said cavity, whereby said membrane (9) is inserted between the wires (18) and the mold part (16) that is used in the molding of the inside surface (15) of the sole (1) in the closed state of the mold.

10. Mold for the manufacturing of an outsole (1) according to claim 1, whereby said mold comprises at least two parts (17, 16), one (17) being used in the molding of the inside surface (15), and the other (16) in the molding of the outside surface (2) of said sole (1), whereby said mold parts (17, 16) are mobile between an open position and a closed position in which they delimit a molding cavity (20) inside of which the constituent molding material of the sole (1) is introduced, wherein the mold part (16) that is used in the molding of the outside surface (2) of said sole (1) is pre-equipped with wires (18), mounted on a spring (19), resting in the closed position of the cavity on the mold part (17) that is used in the molding of the portion that forms a bridge (7) from the inside surface (15) of the sole (1), whereby said wires (18) are installed in the molding cavity at locations that correspond to the through holes (8) for communication between inside surfaces (15) and outside surfaces (2) of the sole that is to be formed.
